(19) United States
(12) Patent Application Publication
(10) Pub. No.: US 2006/0288030 A1
(43) Pub. Date: Dec. 21, 2006

(54) Early hash join

(76) Inventor: Ramon Lawrence, Winnipeg (CA)

Correspondence Address: NEEDLE & ROSENBERG, P.C., SUITE 1000, 999 PEACHTREE STREET, ATLANTA, GA, 30309-3915, US

(21) Appl. No.: 11/449,117

(22) Filed: Jun. 8, 2006

Related U.S. Application Data
(60) Provisional application No. 60/688,800, filed on Jun. 9, 2005.

(51) Int. Cl. G06F 7/00

(52) U.S. Cl. 707/101

(57) ABSTRACT

Minimizing both the response time to produce the first few thousand results and the overall execution time is important for interactive querying. Current join algorithms either minimize the execution time at the expense of response time or minimize response time by producing results early without optimizing the total time. Disclosed herein is a hash-based join algorithm, called early hash join, which can be dynamically configured at any point during join processing to tradeoff faster production of results for overall execution time. Varying how inputs are read has a major effect on these two factors and provide formulas that allow an optimizer to calculate the expected rate of join output and the number of I/O operations performed using different input reading strategies.

### CROSS REFERENCE TO RELATED PATENT APPLICATIONS

This application claims priority to U.S. Provisional Application No. 60/688,800 filed Jun. 9, 2005, herein incorporated by reference in its entirety.

### BACKGROUND OF THE INVENTION

An increasing number of database queries are executed by interactive users and applications. Since the user is waiting for the database to respond with an answer, the initial response time of producing the first results is very important. The user can process the first results while the database system efficiently completes the entire query. Current join algorithms are not ideal for this setting. Hybrid hash join (HHJ) requires that the smaller relation be completely read and partitioned before any output can be generated. This can result in a long response time, especially in a query with multiple joins. Recently, algorithms that produce results “early” (before having read an entire input) have been proposed based on sorting and hashing. However, most of these algorithms were primarily designed for returning answers in data integration systems where the join algorithm should handle network latency, delays, and source blocking. The algorithms are not optimized for the more predictable inputs in centralized database join processing, and consequently, some optimizations to reduce the total execution time are not considered. Early join algorithms were primarily developed for use in integration scenarios where a mediator must join inputs that come from distributed sources. Since the inputs are distributed, the query execution time is affected by network delays, bandwidth, and potential blocking. Instead of dynamically changing the query execution tree (query scrambling), the join operator can adapt its execution to the network conditions. Current algorithms switch to different processing when both inputs are blocked.

There are several algorithms based on hashing and sorting for the early production of results. The first hash-based algorithm was symmetric hash join (SHJ). SHJ works by keeping in memory a hash table for each input. When a tuple arrives, it is used to probe the hash table of the other input, which may generate join results, and then is inserted in the hash table for its input. This process allows join results to be produced before reading either relation entirely. SHJ assumes both hash tables fit entirely in memory. DPHJ, XJoin, and hash-merge join (HMJ) extend SHJ to support joins where the memory could not hold both relations entirely. This creates two new challenges. First, there must be a flushing policy that determines which tuples to flush to disk when memory is full. The second challenge is not to generate duplicate results. Duplicate results are possible in the final phase when all tuples from both inputs have been read and the final cleanup join is performed.

XJoin is a three stage join algorithm that flushes the largest single partition to handle memory overflow. The first stage runs when a tuple from at least one input is available. The second stage runs when both inputs are blocked. The third stage executes after all inputs are received by performing a cleanup join. Duplicates are avoided by assigning an arrival and departure timestamp to each tuple. MJoin is an extension of XJoin for streams that uses metadata to purge tuples that are no longer needed. XJoin has been generalized to an N-way join algorithm for streaming sources that uses coordinated flushing to flush the matching partitions in all N tables.

Hash-merge join (HMJ) uses an adaptive flushing policy that attempts to keep the memory balanced between the two inputs as this optimizes the number of results produced. By flushing a pair of partitions, timestamps are not required to prevent duplicates. A flushed partition is sorted before being written to disk as the blocking phase performs a modified progressive merge join to produce results when both sources are blocked.

There have been no previous algorithms that take into account the impact of different input reading strategies on overall join execution time. A reading strategy is the rules an algorithm uses to decide how to read from the two inputs when both inputs have tuples available. However, different reading strategies have been investigated to improve the convergence of confidence intervals in online aggregation (ripple joins) and for evaluating top-k queries. Maximizing the output rate of streaming sources has also been studied, and joins for data streams aim to maximize the output rate based on stream properties. Furthermore, the flushing policies in previous algorithms are designed solely to optimize result production and do not minimize the total execution time.

### SUMMARY OF THE INVENTION

Disclosed herein is a hash-based join algorithm specifically designed for interactive query processing that has a fast response time like other early join algorithms with an overall execution time that is significantly shorter. Minimizing both the response time to produce the first few thousand results and the overall execution time is important for interactive querying. Current join algorithms either minimize the execution time at the expense of response time or minimize response time by producing results early without optimizing the total time. Disclosed herein is a hash-based join algorithm, also referred to as early hash join, which can be dynamically configured at any point during join processing to tradeoff faster production of results for overall execution time. The effect of varying how inputs are read on these two factors is provided. Further, formulas that allow an optimizer to calculate the expected rate of join output and the number of I/O operations performed using different input reading strategies are disclosed. Experimental results show that early hash join performs significantly fewer I/O operations and executes faster than other early join algorithms, especially for one-to-many joins. Its overall execution time is comparable to standard hybrid hash join, but its response time is an order of magnitude faster. Thus, early hash join can replace hybrid hash join in any situation where a fast initial response time is beneficial without the penalty in overall execution time exhibited by other early join algorithms.

Early hash join reduces the total execution time and number of I/O operations by biasing the reading strategy and flushing policy to the smaller relation. It is advantageous to have complete partitions in memory, so when a probe is performed that falls into that partition, the probe tuple can be discarded once the probe is complete. When producing results early, this requires having read and buffered entirely in memory partitions of the smaller relation. Defined herein is a biased flushing policy to guarantee that complete partitions of the smaller relation remain in memory to use this optimization to improve performance.

The method has both a rapid response time and a fast overall execution time. Formulas are provided for predicting how different input reading strategies effect the expected output rate and number of I/O operations for early hash-based joins. A biased flushing policy is provided that favors keeping complete partitions of the smaller relation in memory, which reduces the overall number of I/O operations performed. A duplicate detection policy is provided that does not need any timestamps for one-to-many joins and only needs one timestamp for many-to-many joins. An experimental evaluation demonstrating early hash join outperforms other hash-join algorithms in overall execution time is also provided.

The disclosed method can be used for joins in centralized database systems and for distributed joins in mediator systems using its background process. The disclosed method can be modified for online aggregation if the inputs are randomly sampled before joining. Furthermore, EHJ can be suitable for use with stream joins, provided the stream has suitable metadata punctuation. Additional advantages of the invention will be set forth in part in the description which follows, and in part will be obvious from the description, or may be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiment(s) of the invention and together with the description, serve to explain the principles of the invention.

FIG. 1 is a block diagram illustrating an exemplary dual hash table structure.

FIG. 2 is a logic flow diagram illustrating an exemplary first phase of the operation of the disclosed method.

FIG. 3 is a logic flow diagram illustrating an exemplary insertion process in the operation of the disclosed method.

FIG. 4 is a logic flow diagram illustrating an exemplary second phase, clean-up phase, in the operation of the disclosed method.

FIG. 5 is a logic flow diagram illustrating an exemplary time-check/probing process in the operation of the disclosed method.

FIG. 6 is a logic flow diagram illustrating an exemplary memory overflow process in the operation of the disclosed method.

FIG. 7 is a logic flow diagram illustrating an exemplary probing process in the operation of the disclosed method.

FIG. 8 is a summary of the performance of various algorithms in terms of response and overall times and number of page I/Os performed.

FIG. 9 shows the execution time of various algorithms during an exemplary *:* join procedure.

FIG. 10 shows the number of I/Os of various algorithms during an exemplary *:* join procedure.

FIG. 11 shows the execution time of various algorithms during an exemplary 1:* join procedure.

FIG. 12 is a table showing inserts avoided, tuples discarded from the hash table, and total tuple I/Os during an exemplary join procedure.

FIG. 13 shows execution time of various algorithms during an exemplary *:* join procedure.

FIG. 14 is a table summarizing response times of various algorithms during an exemplary join procedure for different memory sizes.

FIG. 15 shows execution time of various algorithms during an exemplary multiple join procedure.

FIG. 16 is a block diagram illustrating an exemplary operating environment.

FIG. 17 is a logic flow diagram illustrating an exemplary Early Hash Join method.

FIG. 18 is a logic flow diagram illustrating an exemplary Early Hash Join method.

### DETAILED DESCRIPTION OF THE INVENTION

The present invention may be understood more readily by reference to the following detailed description of preferred embodiments of the invention and the Examples included therein and to the Figures and their previous and following description.

Before the present methods are disclosed and described, it is to be understood that this invention is not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “a tuple” includes mixtures of tuples, reference to “a tuple” includes mixtures of two or more such tuples, and the like.

Ranges may be expressed herein as from “about” one particular value, and/or to “about” another particular value. When such a range is expressed, another embodiment includesfrom the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. “Optional” or “optionally” means that the subsequently described event or circumstance may or may not occur, and that the description includes instances where said event or circumstance occurs and instances where it does not. For example, the phrase “optionally substituted partitions” means that partitions may or may not be substituted and that the description includes both unsubstituted partitions and partitions where there is substitution.

As an illustrative database, the TPC Benchmark TM. H (TPC-H) database (see http://www.tpc.org), incorporated herein by reference in its entirety, which contains information about parts, the suppliers of those parts, customers, and their part orders, will be used.

The disclosed method is described using relational database terminology known to those skilled in the art. For example, records can be referred to as rows. Records can have columns which contain attributes of a record. Records can be grouped together to form tables, or relations. The disclosed method pertains generally to a database join procedure. Such a procedure can involve outputting records from various tables which have common attributes.

Reference will now be made in detail to the present aspects of the invention, examples of which are illustrated in the accompanying drawings. Wherever possible, the same reference numbers are used throughout the drawings to refer to the same or like parts. I.

Reading and Flushing

In this section, the effect of reading strategies and flushing policies on the early production of results is provided. The two relations being joined can be represented by R and S with |R|≦|S|. Let there be N distinct join key values in R and S combined. The number of tuples with join key j in R (S) is denoted by rⱼ (sⱼ). Thus, |R|=Σⱼ₌₁^{N} rⱼ. The selectivity of the join, σ, is the number of join results divided by the size of the cross product, or equivalently

$$σ = \frac{{\sum }_{j = 1}^{N} {r}_{j} * {s}_{j}}{\vert R \vert * \vert S \vert} .$$

Note that the analysis does not restrict R and S to be base relations. Thus, the selectivity, σ, of the join is an estimate produced by the optimizer and encompasses the possibility that selection predicates may have been performed on one or both relations before the join or may be the products of previous join operators.

The goal is to determine E(T(k)), which is the expected number of results generated after k tuples have been read. r(k) and s(k) represent the number of tuples read from R and S after k tuple reads. These values depend on the reading strategy chosen.

A. Reading Strategy

The term reading strategy can be used to refer to how a join operator reads from its inputs. An example of a reading strategy is to read all of the smaller input then all of the larger input. Another reading strategy is to read alternately from inputs: read a tuple from R, then from S, then R, etc. Reading strategies are not applicable to push-based streams if the join processing rate is faster than the input arrival rate (as a tuple would be processed as soon as it arrives). However, joins in centralized databases are pull-based, as the join algorithm can control how it reads its inputs. The inputs can be scanned as they are stored on disk and are not randomly sampled. Every time the join requests a tuple from an input, it gets the next tuple as would be returned in a sequential scan. A reading strategy can be used with regular table scans (or any other iterator operator), and incurs no random I/Os within a relation (but there can be random I/Os when switching the input relation being read). Although the reading strategies disclosed herein are at the tuple granularity, for performance reasons, the actual I/O performed can be at the granularity of several pages or even tracks to reduce the number of random I/Os.

The effect of reading strategy on two common join situations: many-to-many (*:*) joins when the inputs are not sorted on the join key, and one-to-many (1:*) joins where only the one-side input is sorted on the join key is disclosed herein. The general many-to-many case is relatively rare, in comparison to the one-to-many case that occurs when joining from primary key to foreign key. In the many-to-many case, each tuple read is a random sample in the statistical sense because it is not known what value of the join key will be read. In practice, there may be some clustering which makes each sample not completely independent. This is different than relation or stream sampling where true random samples are taken. Inputs are not randomly sampled (they are read sequentially), but if unsorted, reading the first tuple approximates an independent random sample. This is acceptable as randomness is only used to estimate the expected join output rate and not to make statistical guarantees as required for online aggregation. Thus, the presence of clustering would only affect the accuracy of the prediction, not the actual performance of the algorithm.

i. Infinite Memory Case

The infinite memory case applies when both relations can fit entirely in memory or in the first phase of the algorithms where the number of tuples read so far fit entirely in memory. The expected number of join results, E(T(k)), for many-to-many joins and one-to-many joins are given in Formulas 1 and 2 respectively.

$$\begin{matrix}E ( T ( k ) ) = σ * r ( k ) * s ( k ) & ( 1 ) \\ E ( T ( k ) ) = \frac{s ( k )}{\vert S \vert} * {\sum }_{j = 1}^{r ( k )} {s}_{j} & ( 2 )\end{matrix}$$

These equations are derived from the observation that all tuples of R and S read will be matched at time k as all are in memory at the same time. In the many-to-many case, the actual tuples selected from R and S are not known, but the expected value can be calculated. For the one-to-many case, the formula relies on knowing the distribution of S (the sⱼ values). If this is not known, a uniform distribution can be assumed in which case the formula reduces to E(T(k))=r(k)*s(k)/|R|. Note that the one-to-many formulas implicitly assume a non-nullable foreign key. That is, every tuple of S is assumed to join with a tuple of R. If that is not the case, then a multiplicative factor F can be added to both formulas where F is in the range 0 . . . 1 and is the fraction of tuples that have non-null join keys in S.

For a fixed reading strategy, r(k) and s(k) can be specified using exact formulas. For example, in an alternate (1:1) strategy, r(k)=k−s(k) and s(k)=floor(k/2). Thus, it is possible at any time to know exactly how many join results are expected after k tuple reads. For an A:B reading strategy (read A tuples from R and B tuples from S), r(k)=k−s(k) and s(k)=B*k/(A+B). Note that r(k)≦|R| and s(k)≦|S|, so the formulas for r(k) and s(k) are slightly more complex than shown.

Using the formulas for E(T(k)), it is possible to exactly calculate the difference in expected output rate for various fixed reading strategies. The difference of A:B reading versus 1:1 reading is given by the formula: (A−B)²/(A+B)². For instance, 2:1 reading results in 11% fewer results than 1:1 reading, 3:1 reading=25% fewer results, and 3:2 reading=4% fewer results after k tuple reads. Alternate (1:1) reading optimizes the number of tuples matched at any stage. Let x be the number of reads generated by a reading strategy for s(k) after k reads. Then, the expected number of tuples matched is r(k)*s(k)=(k−x)*x. Differentiating this formula and solving gives x=k/2. Keeping memory balanced maximizes the output rate as at any point in time the best input to read from is the input with the fewest tuples in memory. If the memory is not yet full and the sources always have input available, this results in an alternating reading strategy. Although alternate reading is an optimal fixed strategy, strategies that use the distributions of R and S and knowledge of past reads can improve the join output rate. While fixed reading strategies are specifically disclosed herein, other strategies are contemplated such as a greedy strategy where the system selects the input to read from based on information on the tuples read so far and the distributions of the two input relations and other strategies as known to those skilled in the art. The formulas provided, with an estimate of join selectivity (σ), allow an optimizer to estimate how much memory should be allocated to a join to produce a certain number of results without having to perform any I/O operations.

ii. Finite (Full) Memory Case

Determining E(T(k)) for the finite memory case depends on the flushing policy used. An approximation for E(T(k)) for many-to many joins with memory size M is given in Formula 3.
E(T(k))=σ(r(M)*s(M)+2q*(k−M)*(1−q)*M) (3)

This formula holds when k>=M and as long as both inputs still have tuples available. q is the fixed ratio of reading from R compared to S (for an A:B strategy,

$$q = \frac{A}{A + B} ) .$$

The origin of the formula is a calculation of how many tuples of R are read after k steps ((k−M)*q) times how many tuples of S are in memory to be joined with ((1−q)*M). The same reasoning holds for S and results in the factor of two in the formula. This approximation requires that the memory be allocated at approximately the same ratio as the inputs are read. This is an approximation of hash-merge join that reads alternately and keeps memory balanced, in which case the formula simplifies to: E(T(k))=σ*(r(M)*s(M)+0.5*M*(k−M)).

Using Formula 3, several important metrics of early join algorithms can be estimated. First, estimate the expected output rate per tuple read after memory is full, which is 2*σ*M*q*(1−q). Second, estimate how many of the results are generated after all inputs are read but before the cleanup join phase is performed: E(T(M))+σ*M*((1−q)*(|R|−r(M))+q*(|S|−s(M)))

For example, let |R|=|S|=500,000, M=300,000, q=0.5, and σ=0.00001. Then, the expected number of results generated before memory is full is 225,000. After memory is full, 1.5 output tuples are generated per tuple read, and an algorithm that maintains memory ratio q throughout its execution is expected to generate 1,275,000 tuples before the cleanup pass (51% of the total 2,500,000 result size).

B. Flushing Policy

The flushing policy determines which tuples in memory are flushed to disk when memory must be released to accept new input. There are several choices to be made. The first choice is whether to flush a partition from a single source or matching partitions in both sources (coordinated flushing). A decision also must be made on how to select the partition to be flushed. Possibilities include: flush all partitions, flush the smallest, flush the largest, or flush the partition pair that keeps memory balanced (adaptive). Another choice is if a partition can accept new tuples after it is flushed (replacement) or does the partition become frozen and new tuples that hash to the partition are directly flushed to disk (non-replacement).

An adaptive flushing policy that keeps memory balanced between the two inputs optimizes the expected number of results, but has reduced performance when R is significantly smaller than S. The reason is that the memory will not remain balanced once all of R is read, as only S will remain in memory after many partition pairs are flushed, and eventually this results in flushing empty R partitions.

There is a benefit to favoring the smaller relation R in memory as this allows I/Os to be prevented. Any tuple of S that probes an in-memory partition of R is discarded (avoids I/Os). A flushing policy that flushes partition pairs (does not favor smaller relation R) cannot take full advantage of reducing I/Os as there is no guarantee that entire partitions of R are in memory after all of R has been read.

It is possible to discard tuples of S after all of R has been read, and entire partitions of R are in memory when probing. The expected number of I/O operations saved if a flushing policy preserves entire partitions of R can be estimated. In the best case of hybrid hash join a fraction f of R's partitions remain in memory after R is partitioned. The expected number of tuples of S that fall into these partitions is f*|S|, and each tuple discarded saves two tuple I/Os. When producing results early, the savings only apply for any tuple of S read after all of R is read. Consider an algorithm that reads from R and S at a ratio q1 before memory is filled and q2 after memory is full. For example, if the algorithm initially performed 1:1 reading and then switched to 3:1 reading, q₁=0.5 and q₂=0.75. Let M be the size of memory in tuples. The number of tuples of S remaining, leftS, after all of R has been read is leftS=|S|−M*(1−q₁)−(1−q₂)*(|R|−M*q₁)/q₂. Each of the tuples have a probability f of falling into an in-memory partition of R. Thus, the expected number of I/O operations avoided is 2*f*(|R|+leftS).

Consider alternate reading. The number of tuples discarded is |S|R−|R|. In practice, S is often multiple times larger than R, especially for one-to-many joins. For example, in TPC-H the Orders relation is 10 times larger than the Customer relation. Consider a 1 GB TPC-H database size which has 150,000 tuples in Customer and 1,500,000 in Orders. With alternate reading, 10% of Orders is read before Customer is completely read. Thus, leftS=1,350,000. If f=0.5 (50% of Customer can fit in memory), then 675,000 tuples of Orders can be joined immediately with in-memory Customer partitions and discarded. This compares with the maximum possible of 750,000 achievable using hybrid hash join (or equivalently, the strategy of reading all of R before any of S).

An even larger benefit occurs by biased reading of R over S. The formula indicates that there is a benefit of reading all of R as quickly as possible which conflicts with the goal of producing results as early as possible. The total number of I/Os and the total execution time can be reduced by flushing and reading policies that get complete partitions of R in memory as soon as possible.

C. One-to-Many Join Optimization

One-to-many joins are the most common type of join and occur when joining with foreign keys. An optimization designed for stream joins can be applied to all of the previous early, hash-based join algorithms. Simply, if a tuple from S (the many-side) produces a join result, that tuple can be discarded as it not possible for it to produce any more results.

This can apply in the many-to-many join case. A tuple T_{S} from S can be discarded if T_{S} is matched with all tuples that it could potentially match with. When considering early production of results two things can be considered: 1) the entire relation R must have been read and 2) the partition of R that T_{S} would probe must be completely in memory. This optimization favors reading R as quickly as possible and encourages the flushing policy to be biased so that portions of R partitions are not flushed from memory.

II. Early Hash Join (EHJ) Algorithm

The early hash join (EHJ) algorithm allows the optimizer to dynamically customize its performance to tradeoff between early production of results and minimal total execution time. The first phase of the algorithm where memory is available should be optimized to produce results as quickly as possible. Once memory is full, the algorithm should switch to optimizing the total execution time but still continue to produce results. Interactive users are initially interested in only the first few hundred or thousand results which can often be produced before memory is full. Then, the rest of the results should be produced as quickly as possible, but there is less motivation to continue to produce results as early as possible at the expense of total performance.

Early hash join uses one hash table for each input. A hash table consists of P partitions. Each partition consists of B buckets. A bucket can store a linked list of pages, where each page can store a fixed number of tuples. When a tuple from an input arrives, it can first be used to probe the hash table for the other input to generate matches. Then, it can be placed in the hash table for its input. In this first in-memory phase, alternate reading can be used by default. However, it is possible to select different reading strategies (that favor R) if the bias is to minimize total execution time. At any time, the user/optimizer can change the reading policy and know the expected output rate.

Once memory is full, the algorithm can enter a second phase (referred to as the flushing phase). In the flushing phase, the algorithm uses biased flushing to favor buffering as much of R in memory as possible. By default, it increases the reading rate to favor reading more of R. This reduces the expected output rate, but decreases the total execution time. In both phases, the optimizations to discard tuples when performing one-to-many joins and many-to-many joins once all of R has been read are performed. For one-to-many joins, if a tuple from R matches tuple(s) in S in the hash table, then those tuples must be deleted from the hash table. Once the flushing phase begins, a concurrent background process can be activated if the inputs are slow. After all of R and S have been read, the method can perform a cleanup join to generate all possible join results missed in the first two phases. This cleanup join can occur in two passes. In pass one, for each partition Rᵢ in memory, it is probed with its matching on-disk partition Sᵢ. The hash table can then be cleared before the second pass begins. In pass two, an on-disk partition Rᵢ can be loaded into memory and a hash table can be constructed for it, then its matching partition Sᵢ can be used to probe the hash table of Rᵢ. An output involving tuple T_{S} from Sᵢ with T_{R} from Rᵢ can be generated if the join tuple has not been generated before. In the following sections, further details on the reading strategy, flushing policy, duplicate prevention, and the background process are provided.

A. Generally

In one aspect, provided is a method for joining relations comprising receiving a first relation (“R”) and a second relation (“S”) (step 1701), generating a dual hash table having a first side (“R”) and a second side (“S”) (step 1702), reading a first tuple from the second relation (“S”) (step 1703), probing the first side (“R”) of the dual hash table (step 1704), outputting a result of the probe (step 1705), and inserting the first tuple into the second side (“S”) of the dual hash table (step 1706). The first relation (“R”) can be smaller than the second relation (“S”). The tuples can be read according to a reading policy. The reading policy can be, for example, an alternating reading policy. The inserting can comprise placing the first tuple into a corresponding bucket. The method can further comprise, determining a relation of origin for the first tuple.

The probing can comprise determining a bucket number, determining if the bucket number corresponds to a frozen partition, retrieving a second tuple from the bucket, comparing the first tuple and the second tuple, determining if a join key of the first tuple and a join key of the second tuple match a user specified predicate, outputting the join result, and repeating steps c-f until every tuple in the bucket has been compared to the second tuple. The probing can still further comprise determining if the requested join is a 1:* join, determining if the second tuple is from the *-side of the 1:* join, and deleting the second tuple, if the second tuple is from the *-side of the 1:* join.

The method can further comprise determining if memory is full and initiating a memory overflow process if memory is full. The memory overflow process can comprise determining if a memory overflow process has been previously performed, determining if there is a non-frozen partition of the second relation wherein the largest non-frozen partition of the second relation is flushed if there is a is a non-frozen partition of the second relation or the smallest non-frozen partition of the first relation is flushed if there is no non-frozen partition of the second relation. The memory overflow process can further comprise changing the reading policy if a memory overflow process has been previously performed.

The method can further comprise initiating a clean up phase if there are no tuples remaining to be read from the relations. The clean up phase can comprise determining if a clean up phase has been previously performed, determining if there is an on-disk partition of the first relation and the second relation or only an on-disk partition of the second relation wherein the first relation is loaded into memory if there is an on-disk partition of the first relation and the second relation, initializing a probe file for the partition containing the second relation, reading a tuple from the probe file, determining if there is input remaining in the probe file, closing the probe file, and deleting on-disk partitions. Another tuple is read from the probe file if it is determined that input remains in the probe file. A second clean up phase can be initialized if there is no on-disk partition of the second relation where the matching partition of the first relation is in memory. The join is complete if there is no on-disk partition of either the first relation or the second relation.

In another aspect, provided is a method for joining relations comprising receiving a first relation and a second relation (step 1801), generating a dual hash table having a first side and a second side (step 1802), determining if a tuple exists in either the first relation or the second relation (step 1803), initiating a clean up phase if there are no tuples remaining to be read from the relations wherein the clean up phase produces any remaining results that were missed when input was being read (step 1804), reading a first tuple from one of the relations according to one of a plurality of reading policies wherein the reading policy determines which of the first or second relations is read (step 1805), probing the dual hash table (step 1806), determining if memory is full (step 1807), and initiating a memory overflow process if memory is full wherein the memory overflow process comprises a biased flushing policy that favors the smaller relation (step 1808). The method can further comprise outputting a result of the probe.

The memory overflow process can comprise determining if a memory overflow process has been previously performed, determining if there is a non-frozen partition of the second relation wherein the largest non-frozen partition of the second relation is flushed if there is a is a non-frozen partition of the second relation or the smallest non-frozen partition of the first relation is flushed if there is no non-frozen partition of the second relation. The memory overflow process can further comprise changing the reading policy if a memory overflow process has been previously performed.

The method can further comprise initiating a clean up phase if there are no tuples remaining to be read from the relations. The clean up phase can comprise determining if a clean up phase has been previously performed, determining if there is an on-disk partition of the first relation and the second relation or only an on-disk partition of the second relation wherein the first relation is loaded into memory if there is an on-disk partition of the first relation and the second relation, initializing a probe file for the partition containing the second relation, reading a tuple from the probe file, determining if there is input remaining in the probe file, closing the probe file, and deleting on-disk partitions. Another tuple is read from the probe file if it is determined that input remains in the probe file. A second clean up phase can be initialized if there is no on-disk partition of the second relation where the matching partition of the first relation is in memory. The join is complete if there is no on-disk partition of either the first relation or the second relation.

In yet another aspect, provided is a system for joining relations comprising a memory for storing relations wherein the relations comprise tuples and a processor coupled to the memory, wherein the processor is configured to perform the steps of receiving a first relation and a second relation, generating a dual hash table having a first side and a second side, determining if a tuple exists in either the first relation or the second relation, initiating a clean up phase if there are no tuples remaining to be read from the relations wherein the clean up phase produces any remaining results that were missed when input was being read, reading a first tuple from one of the relations according to one of a plurality of reading policies wherein the reading policy determines which of the first or second relations is read, probing the dual hash table, determining if memory is full, and initiating a memory overflow process if memory is full wherein the memory overflow process comprises a biased flushing policy that favors the smaller relation. The system can further comprise a display device for displaying a result of the probe.

The processor can be further configured so that the memory overflow process can comprise determining if a memory overflow process has been previously performed, determining if there is a non-frozen partition of the second relation wherein the largest non-frozen partition of the second relation is flushed if there is a is a non-frozen partition of the second relation or the smallest non-frozen partition of the first relation is flushed if there is no non-frozen partition of the second relation. The memory overflow process can further comprise changing the reading policy if a memory overflow process has been previously performed.

The processor can be further configured for initiating a clean up phase if there are no tuples remaining to be read from the relations. The clean up phase can comprise determining if a clean up phase has been previously performed, determining if there is an on-disk partition of the first relation and the second relation or only an on-disk partition of the second relation wherein the first relation is loaded into memory if there is an on-disk partition of the first relation and the second relation, initializing a probe file for the partition containing the second relation, reading a tuple from the probe file, determining if there is input remaining in the probe file, closing the probe file, and deleting on-disk partitions. Another tuple is read from the probe file if it is determined that input remains in the probe file. A second clean up phase can be initialized if there is no on-disk partition of the second relation where the matching partition of the first relation is in memory. The join is complete if there is no on-disk partition of either the first relation or the second relation.

Portions of the methods and systems generally provided above will now be disclosed in more detail in the following sections.

B. Reading Strategy

By way of example, by default, the method can perform alternate reading in the in-memory phase and 5:1 reading in the flushing phase. These reading policies are configurable by the optimizer, and can also be changed interactively as the join is progressing or after a certain number of output results have been generated. During the flushing phase, the system can default to reading all of R before any of S to minimize total execution time, however, the reading strategy can be changed to any reading strategy known to those skilled in the art. These settings are chosen because in interactive querying the priority of the first few results is much higher than later query results. However, other reading strategies can be used as are known in the art.

C. Biased Flushing Policy

The biased flushing policy favors flushing partitions of S before partitions of R. This is similar to an incremental left flush except that the method is not forced to switch to reading all of one of the relations and can continue to use whatever reading strategy is desired. This is achieved because the disclosed method for detecting duplicates using timestamps is more powerful than using Boolean flags on each tuple. The biased flushing policy uses these rules to select a victim partition whenever memory must be freed:
Select the largest, non-frozen partition of S.
If no such partition of S exists, then select the smallest, non-frozen partition of R.

Once a partition is flushed, all buckets of its hash table are removed and are replaced by a single page buffer. This partition is considered frozen (non-replacement) and cannot buffer any tuples in memory (except for the single page buffer) and cannot be probed. If a tuple hashes to this partition, it is placed in the page buffer which is flushed when filled. If a tuple in the other input hashes to this partition index, then no probe is performed.

D. Analysis

Using the formulas disclosed, the expected number of tuple I/O operations performed by the method and its expected output in its various stages can be estimated. For this analysis, assume a fixed A1:B1 reading policy for the in-memory phase and a fixed A2:B2 reading policy that begins when the flushing phase begins. Let

$${q}_{1} = \frac{{A}_{1}}{{A}_{1} + {B}_{1}}$$

$$and$$

$${q}_{2} = \frac{{A}_{2}}{{A}_{2} + {B}_{2}} .$$

Assuming that M≦|R|, let f=M/|R| be the fraction of R partitions completely in memory after all of R has been read. The number of I/O operations (not counting reading inputs) is: 2*(|R|+|S|−f*R|−f*LeftS) where lefts=|S|−M*(1−_{q1})−(1−_{q2})*(|R|−M*q₁)/q₂. A savings is provided by keeping a fraction f of R in memory and save a fraction f of the tuples of S read after all of R is read (leftS).

In the exemplary default configuration of EHJ (1:1 reading then 5:1 reading), the number of I/O operations is 2*(|R|+|S|−f*(|S|−f*(|S|−0.4M−|R|/5). For small memories, the number of I/Os for EHJ and DHJ is very close. For larger memories, EHJ performs more I/Os because 1:1 reading is used until memory is full. This motivates switching from 1:1 reading even before memory is full in many cases.

In the infinite memory stage, the number of outputs expected after k tuple reads can be calculated exactly. Analysis of the expected output rate for a fixed reading policy in the flushing phase is difficult to determine exactly. Let c be the fraction of memory occupied by tuples of R. When flushing begins, c=q₁, for a fixed reading strategy A1:B1. Eventually, c will go to 1 due to biased flushing. At that point, the expected output rate is σ*(1−q₂)*M as only tuples from S can potentially generate any output. During the transition period, the expected output rate can be approximated by assuming that a tuple of S gets flushed every time a tuple arrives. It will take N=(M−M*q₁)/q₂ tuple reads before c=1. The fraction c at time k is (k*q₂+M*q₁)/M. Thus, the expected output rate after k tuple reads have been performed after full memory where k≦N is σ*M*(q₂*(1−c)+(1−q₂)*c).

E. Duplicate Detection

Duplicate results are not possible with one-to-many joins because a tuple on the many-side is discarded as soon as it produces a join result. Duplicate detection for many-to-many joins requires assigning an arrival timestamp for each tuple. The arrival timestamp is an increasing integer value that is the count of the number of tuples read so far. The arrival timestamp is stored when the tuple is in memory and is flushed to disk with the tuple if the tuple is evicted from memory. Duplicate detection using timestamps can be used during the last phase of the algorithm after all tuples from R and S have been read and when the background process is executing, if any.

Let T_{R} be a tuple in R and T_{S} be a tuple in S. The timestamps of T_{R} and T_{S} are denoted as T_{S}(T_{R}) and T_{S}(T_{S}) respectively. Let the P partitions of R and S be denoted as R₁,R₂, . . . , R_{P} and S₁,S₂, . . . , S_{P}. When a partition is flushed, record a flush timestamp. For instance, the timestamp that partition 5 of R is flushed is denoted by TS_{F} (R₅). Let the partition index that a tuple T hashes to be P(T). The biased flushing policy guarantees that TS_{F}(Sᵢ)<TS_{F}(R₁).

The EHJ algorithm can detect duplicates during the cleanup phase. A pair of tuples will pass this check if they have not been generated in a previous phase. The timestamp check is true if any one of these three cases hold:

1. T_{S} arrived before its partition of S was flushed and T_{R} arrived after the partition of S was flushed: TS(T_{S})≦TS_{F}(S_{P(TS)}) and TS(T_{R})>TS_{F}(S_{P(TS)})

2. Tₛ arrived after its partition of S was flushed but before the matching partition of R was flushed and T_{R} arrived after T_{S}: TS(T_{S})>TS_{F}(S_{P(TS)}) and TS(T_{S})≦TS_{F}(R_{p(TS)}) and TS(T_{R})>TS(T_{S})

3. T_{S} arrived after partition of R was flushed: TS(T_{S})>TS_{F}(R_{P(TS)})

In the first case, if T_{S} arrived before the partition of S was flushed (note that it may never be flushed), then it would have been matched already with all tuples T_{R} in R_{P(TS)} except those that arrive after the partition of S is flushed as then T_{S} would no longer be in memory. In the second case, if T_{S} arrived after its partition was flushed, it would be directly flushed to disk and would only have joined with the tuples of R currently in memory at that time. Any tuples of R that arrive after T_{S} arrived would not have joined with T_{S}. Finally, if T_{S} arrives after the partition of R is flushed, it would not have joined with any tuples in R and should be joined with all tuples of R.

Duplicate detection is simple because of the predictable flushing pattern of biased flushing and because partitions are frozen once they are flushed. EHJ only needs one timestamp, and timestamps are not needed for one-to-many joins. Duplicate detection with background processing enabled is slightly more complex and is covered in the next section.

F. Background Processing

The background process is concurrent with the main join process in EHJ. Thus, it may be used to increase the output rate as the main join thread is still processing input. The background processing is valuable for distributed joins or joins where the inputs are coming from a different hard drive or device than the join uses for its temporary I/O workspace. Only one background process is ever active, and it can only execute in the flushing phase. If the time since a tuple has been read is greater than a threshold value, and an on-disk partition file of S exists where the expected number of join results is greater than a threshold, the background process can be started. The number of expected results generated is estimated by the partition sizes of R and S, the selectivity of the join, and the last time that on-disk partition S was used to probe R in memory. The partition that is expected to generate the most output results can be selected. There are two other factors when selecting a partition. First, if R has been completely read, all on-disk partitions of S can be used and then discarded. Second, one-to-many joins require special handling to prevent duplicates, as any probe file tuples that produce output must be deleted. To prevent both reading and writing the probe file, the join can be processed like a *:* join, or the activation threshold is raised to factor in the higher cost. An example of a method that can be used to trigger a background process is if the number of results expected to be generated is greater than 10% of the size of the partition of S. However, any metric can be used, including the background process running continually, depending on availability of resources and the relative cost of performing CPU probes and I/O operations. The exact formula used is dependent on the join environment.

The selected partition can be recorded so that the main thread will not flush it from memory while the background process is running. If the partition file of S chosen is the file currently used by the main thread when flushing tuples, the system can close this file, and create a new output file for the main thread to avoid conflicts. Each partition file can be assigned a probe timestamp that is the last time tuples in that file were used to probe the matching R partition. This timestamp is originally the flush timestamp of the partition, and can be set to the current time when a background process begins. The main thread starts the background thread and continues normal processing. The background thread reads a tuple at a time from the partition file and probes the corresponding in-memory partition of R. As output tuples are generated, they are placed on a queue for the main thread to output. When the entire partition file is processed, the thread ends, and the system can start another thread.

Using a background thread changes the duplicate detection strategy as the final cleanup phase must not generate output tuples already generated by the background process. The background process must also not generate duplicate results. Tuples generated by the background process are identified using the probe timestamp stored with each file. For a given partition file used as a probe file either by the background or cleanup process, let this timestamp be lastProbeS. An output tuple matching T_{R} with T_{S} is generated by the background process if T_{R} was in memory the last time the probe file containing T_{S} was used: TS(T_{R})≦lastProbeS and TS(T_{R})≦TS_{F}(P(T_{R})). Then, the timestamp check presented in the previous section is modified by adding to the first two cases the condition: and T_{R} was not in memory before lastProbeS (TS(T_{R})>lastProbeS OR TS(T_{R})>TS_{F}(R_{P(TS)})).

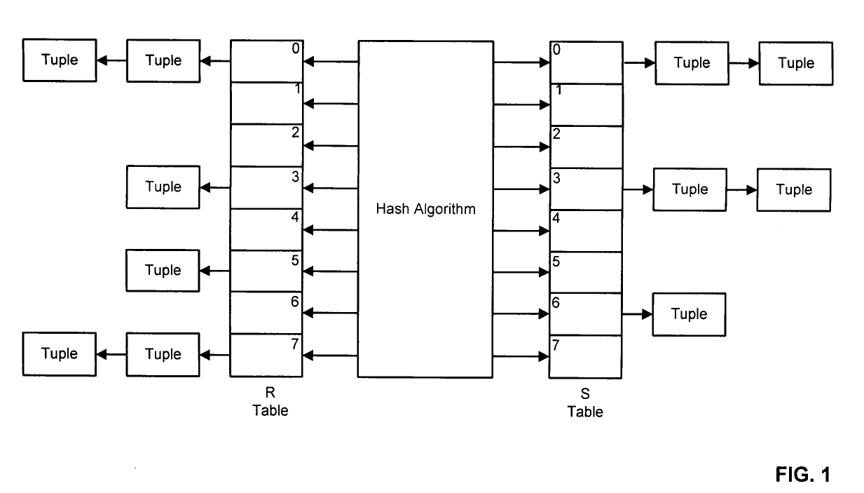

The present method can implement a dual hash table structure capable of hashing a plurality of relations, in FIG. 1 these relations are labeled, for example, “R” and “S”. The term “table” or “relation” is used interchangeably. A hash algorithm can take in one or more attributes of a relation and determine a bucket to place it in. The hash algorithm can take in one or more attributes of a relation and determine an integer, which is a bucket number, and place the tuple in that particular bucket. As demonstrated in FIG. 1, there can be an “R” table and an “S” table, the tuples of R will hash to the “R” side, the tuples of “S” will hash to the “S” side. As a tuple is read and placed into a hash table, it can be assigned a timestamp. Timestamps can include combinations of date and time or generally, an integer. The principle behind a basic hash join is that if a tuple of “R” has a value and a tuple of “S” has the same value and an equi-join is performed, wherein matching is performed based on the same value in a column, both tuples map to buckets with the same value and since the tuples are in the same bucket, they can quickly be identified as a matched pair. EHJ differentiates two types ofjoins. A many-to-many (*:*) join means that a tuple in “R” can match with many tuples in “S” and vice versa. In a one-to-many join (1:*), a tuple in “R” can match with many tuples in “S”, but a tuple in S can match with 0 or 1 tuple in “R”. A one-to-many join occurs when the join condition equates a primary key in “R” with a foreign key “S”.

G. Phase One

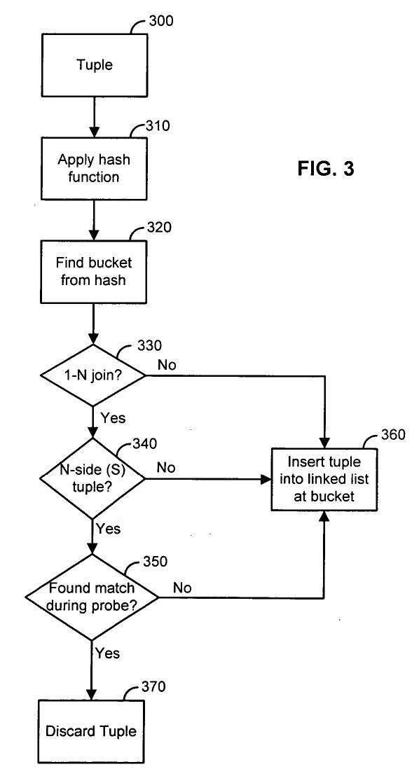

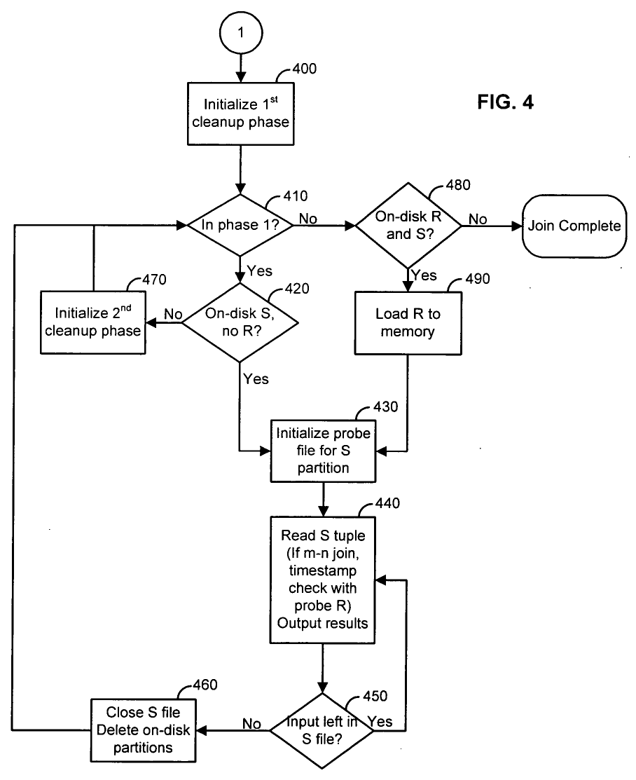

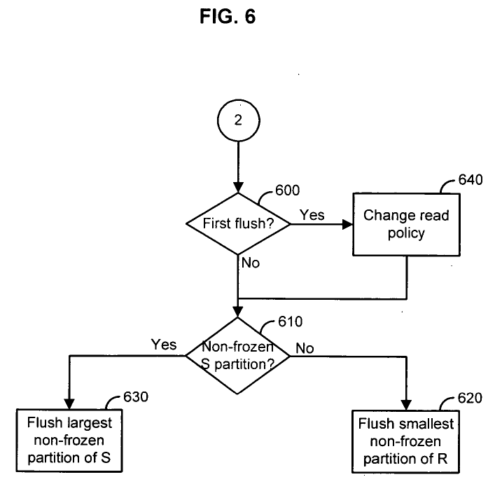

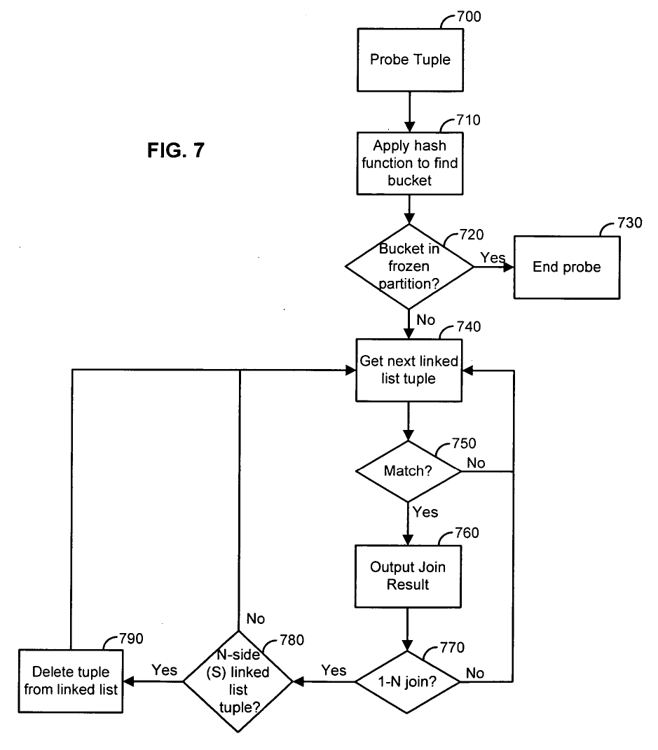

In phase one, the EHJ CAN designate the smaller of two tables as “R” and the larger of the two tables as “S” (step 200). If the tables are the same size, then either table can be designated as R or S. R is also the 1-side of a 1:* join. The set of tuples of R and the set of tuples of S, are considered input. The EHJ can first determine if there is input left, for example, is there a tuple in either R or S, not necessarily both (step 210). If there is no input, the EHJ can enter a cleanup phase, illustrated in FIG. 4 and described in the paragraphs that follow. If a distributed join over a network is being performed, the EHJ detects if the inputs are blocked (delayed for a period of time). If EHJ determines the inputs are blocked and that it is beneficial to perform background processing, a background process can start. If there is input, the EHJ can read a tuple from R or S, depending on the reading policy selected. In the current embodiment, an alternating reading policy performs well when the system has free memory. Therefore, the present method will be described with an alternate reading policy as the initial reading policy. The EHJ will start reading tuple from R (step 220). The EHJ can perform a check to determine if the tuple read is indeed a tuple from R (step 230). If the tuple is from R, the tuple can be used to probe the S side of the dual hash table and the results of the probe can be output (step 240). Then, the tuple from R can be inserted into the R side of the dual hash table. If the tuple is from S, the tuple can be used to probe the R side of the dual hash table and the results of the probe can be output (step 250). Then, the tuple from S can be inserted into the S side of the dual hash table. Details of steps 240 and 250 are disclosed in FIGS. 3 and 7, and described in the following paragraphs. After results, if any, are output (optional), the EHJ can check to determine if memory is full (step 260). If memory is full, the EHJ can enter a memory overflow procedure as described in FIG. 6 and described below. If memory is not full, the EHJ can return to step 210 to check if input is left, if there is, the EHJ can continue the alternate reading policy and now read from S. The EHJ can repeat the steps described above until no input is left. At which time, the EHJ can enter phase 2, the cleanup phase. The cleanup phase is illustrated in FIG. 4 and described below.

FIG. 7 illustrates the procedure for probing. The EHJ attempts to match the probe tuple with tuples from the other relation. The probe tuple is received as input (step 700). The same hash function from the insertion step is applied and determines the bucket number to probe (step 710). The EHJ can check to determine if the bucket is actually in a partition that is frozen (step 720). A frozen partition is a partition that has been previously flushed to disk. Once a partition is frozen, it can no longer accept input and remains frozen throughout the remainder of the join. Partitions are frozen separately for each input, but a partition of R will only be frozen if its corresponding partition of S is already frozen. This happens due to the rules of biased flushing. A frozen partition contains no tuples except a page buffer for buffering output that hashes to the partition. It cannot be probed. If the bucket is in a frozen partition, the probe is terminated since there will be nothing in the linked list for that bucket. Once the probe procedure is terminated (whether output is generated or not), the EHJ can perform the insertion procedure in FIG. 3. If the bucket is not in a frozen partition, the EHJ retrieves the next tuple in the linked list in the bucket (step 740). The EHJ then compares the probe tuple with the tuple retrieved from the linked list and determines if the tuples join keys match the predicate specified by the user during the initial join (step 750). If the join keys do not match, the EHJ retrieves the next tuple in the linked list (step 740). If the join keys match, the join result can be output (step 760). The EHJ can determine if the join is a 1:* join (step 770). If the join is not a 1:* join, the EHJ retrieves the next tuple in the linked list (step 740). If the join is a 1* join, the EHJ determines if the tuple retrieved from the linked list is from the *-side (S) of the join (step 780). If the tuple retrieved from the linked list is not from the *-side, the EHJ retrieves the next tuple in the linked list (step 740). If the tuple retrieved from the linked list is from the *-side, that tuple is deleted from the linked list (step 790) and the EHJ retrieves the next tuple in the linked list (step 740). Steps 770-790, optimize the EHJ, in that if the tuple retrieved from the linked list is from S, it will not continue to match.

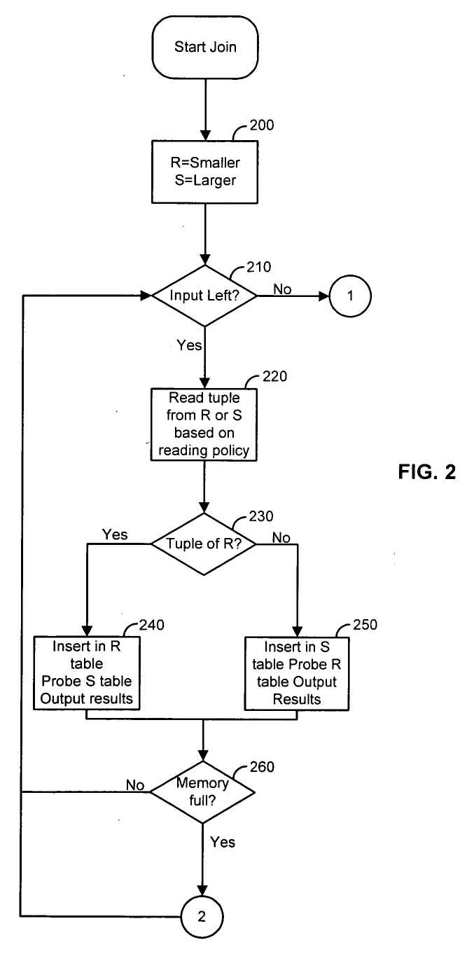

An exemplary tuple insertion procedure is illustrated in FIG. 3. A tuple (step 300) is received as input from either R or S and the hash function is applied (step 310). The hash function is the same whether the tuple is from R or S, as the tuples are mapped to the same bucket range. Any suitable hash function known to those skilled in the art can be applied. By way of example, and not limitation, h(x)=x % 10 can be used. Such a hash function will provide 10 buckets, derived from integers in the range from 0-9. The bucket from the hash in which the tuple should be placed can be determined (step 320). The EHJ can check to determine if the join being performed is a 1:* join (step 330). If the join performed is not a 1:* join, the tuple can be inserted into a linked list in the bucket found previously (step 360) and the EHJ can begin the probe procedure illustrated in FIG. 7. If a 1:* join is being performed, the EHJ can further check to determine if the tuple for insertion is from the *-side (S) of the join (step 340). If the tuple is not from the *-side of the join, the tuple can be inserted into a linked list in the bucket found previously (step 360). If the tuple is from the *-side of the join, the EHJ can determine if the present tuple has matched a tuple from the other side of the join already (step 350). If a match was not found, the tuple is inserted into a linked list in the bucket found previously (step 360). If a match was found during the probe procedure illustrated in FIG. 7, the tuple can be discarded (step 370). Steps 330-350 are an optimization that prevents the EHJ from inserting a tuple into the linked list, if the tuple has matched another tuple already. If this tuple has matched a tuple on the other side of the join and it can only match this one other tuple, there is no reason to put the present tuple into the table. As such, the present tuple can be discarded. The optimization is a method of discarding tuples when there can not be any more matches in the join. Once insertion has completed (step 730), the EHJ returns to step 260, FIG. 2.

As referred to earlier in step 260 in FIG. 2, if the EHJ determines that memory is full, the EHJ can enter a memory overflow phase as illustrated in FIG. 6 in order to flush memory. The EHJ can first determine if this is the first flush that has occurred for this join (step 600). If this is the first flush, the EHJ will change the reading policy. The reading policy can be changed to any reading policy known to those skilled in the art. For purposes of illustration, the EHJ in the present embodiment will change to reading all of R. However, the EHJ can change the reading policy at any point during the entire join procedure. In other embodiments, the reading policy is changed before memory is completely full. If this is not the first flush, or if it is the first flush and the reading policy has been changed, the EHJ can determine if there is a non-frozen partition of S (not currently written to disk) (step 610). If there is a non-frozen partition of S in memory, then the largest non-frozen partition is flushed (step 630). If the non-frozen partitions of S are the same size, then any can be flushed. Biased flushing rules include keeping as much of the larger relation in memory as possible and when a partition is flushed, it is frozen. The combination results in improved performance of the method and the requirement for faster timestamp checking. While described herein as favoring the smaller relation, other variations are contemplated, so long as the partition is frozen once it is flushed and maintaining the larger relation in memory is favored. As used herein, favoring the smaller relation, means flushing the largest partition of the larger relation (“S”) first then the smallest partition of the smaller relation (“R”). The EHJ returns to step 210 illustrated in FIG. 2 and proceeds with the join. If there are no non-frozen partitions of S, the EHJ flushes the smallest partition of R (step 620). The EHJ is attempting to keep as much of the R side in memory, as this will reduce the number of I/O operations performed. The EHJ returns to step 210 illustrated in FIG. 2 and proceeds with the join.

H. Phase Two

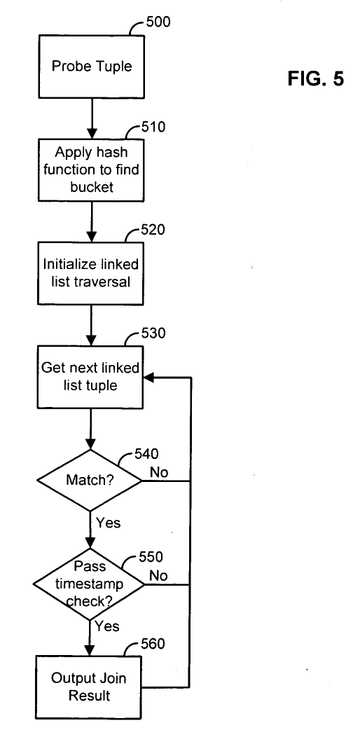

In step 210, FIG. 2, if there is no input left, the EHJ will enter phase 2, clean-up phase as illustrated in FIG. 4. The goal of the clean-up phase is to compute all the output not generated the first phase because of lack of memory. In phase 2, the EHJ initializes the first clean-up phase (step 400). The EHJ can search for the partition pairs where there is an on-disk partition of S, but the matching partition on R is still in memory. The EHJ can check if it is in the first clean-up phase (step 410). If it is, the EHJ can determine if there is a partition where S is on disk and R is in memory (step 420). If there are none, then EHJ can initialize the second clean-up phase (step 470). If there is a partition where S is on disk and R is in memory EHJ can initialize a probe file for the S partition (step 430). Since none of the S partition tuples are in memory the EHJ can read from the partition file all the tuples of S and probe the corresponding partition of R that is in memory, outputting the results, if any (step 440). If the join currently performed is not a *:* join, the probe procedure is described in FIG. 7. If the join currently performed is a *:* join, the probe procedure involves a timestamp check as illustrated in FIG. 5 and described in the following paragraphs. The EHJ can check if there is any input remaining in the S partition file (step 450) and continue to read the input in S, probe and output matching results (step 440). If there is no more input in S, the EHJ will close the S file and delete the on-disk partitions (step 460). EHJ can then re-check to determine if it is still in clean-up phase 1 (step 470). If EHJ is no longer in clean-up phase 1, EHJ can determine if there are any on-disk partitions of R and S (step 480). During the initialization of the 2^{nd} cleanup phase, the contents of the hash table, if any, can be deleted. If there are no on-disk R and S partitions, then the join is complete. If there is a partition where both R and S are on-disk, then EHJ then loads R into memory (step 490) and searches for matches in S as seen in steps 430-460. When R is loaded into memory, it can be loaded into the same dual hash table structured used. However, it is also possible to discard the dual hash table structure completely when starting phase 2, and create a new hash table specifically for each partition of R that is then probed with S.

In step 440, illustrated in FIG. 4, if the join performed is a *:* join, then a special timestamp check and probe procedure is used as illustrated in FIG. 5. The EHJ performs this check and procedure for *:* joins because it is possible to generate a previously returned result by re-probing what was in memory. The probe tuple is received as input (step 500). A hash function can be applied to determine the bucket the probe tuple is found (step 510). The EHJ initializes a linked list traversal (step 520) and retrieves the next tuple in the linked list (step 530). It is not necessary to check for frozen partitions as R is in memory, arranged so before the timestamp probe was initiated. The EHJ can check if there is a match (step 540). If there is no match, the EHJ can return to step 530 and retrieve the next tuple in the linked list. If there is a match, the EHJ can determine if the match passes the timestamp check (step 550). The rules for the timestamp check are:

1. T_{S} arrived before its partition of S was flushed and T_{R} arrived after the partition of S was flushed: TS(T_{S})≦TS_{F}(S_{P(TS)}) and TS(T_{R})>TS_{F}(S_{P(TS)})

2. T_{S} arrived after its partition of S was flushed but before the matching partition of R was flushed and T_{R} arrived after T_{S}: TS(T_{S})>TS_{F}(S_{P(TS)}) and TS(T_{S})≦TS_{F}(R_{P(TS)}) and TS(T_{R})>TS(T_{S})

3. T_{S} arrived after partition of R was flushed: TS(T_{S})>TS_{F}(R_{P(TS)}) The timestamp check determines if this result has been generated before. If the timestamp check fails, the EHJ returns to step 530 and retrieves the next tuple in the linked list. If the timestamp check passes, the join result is output (step 560) and the EHJ returns to step 530 and retrieves the next tuple in the linked list until the list is exhausted and the EHJ returns to step 450 illustrated in FIG. 4.

Using a background thread changes the duplicate detection strategy as the final cleanup phase must not generate output tuples already generated by the background process. The background process must also not generate duplicate results. Tuples generated by the background process are identified using the probe timestamp stored with each file. For a given partition file used as a probe file either by the background or cleanup process, let this timestamp be last ProbeS. An output tuple matching TR with TS is generated by the background process if TR was in memory the last time the probe file containing TS was used: TS(TR)≦last ProbeS and TS(TR)≦TSF (P(TR)). Then, the timestamp check presented in the previous section is modified by adding to the first two cases the condition: and TR was not in memory before last ProbeS (TS(TR)>last ProbeS OR TS(TR)>TSF (RP(TS))). The first two rules are modified to become:

1. TS arrived before its partition of S was flushed and TR arrived after the partition of S was flushed and TR was not in memory before last ProbeS: TS(TS)≦TSF (SP(TS)) and TS(TR)>TSF(SP(TS)) and (TS(TR)>last ProbeS OR TS(TR)>TSF(RP(TS)))

2. TS arrived after its partition of S was flushed but before the matching partition of R was flushed and TR arrived after TS and TR was not in memory before last ProbeS: TS(TS)>TSF (SP(TS)) and TS(TS)≦TSF(RP(TS)) and TS(TR)>TS(TS) and (TS(TR)>last ProbeS OR TS(TR)>TSF(RP(TS)))

The third rule is unchanged.

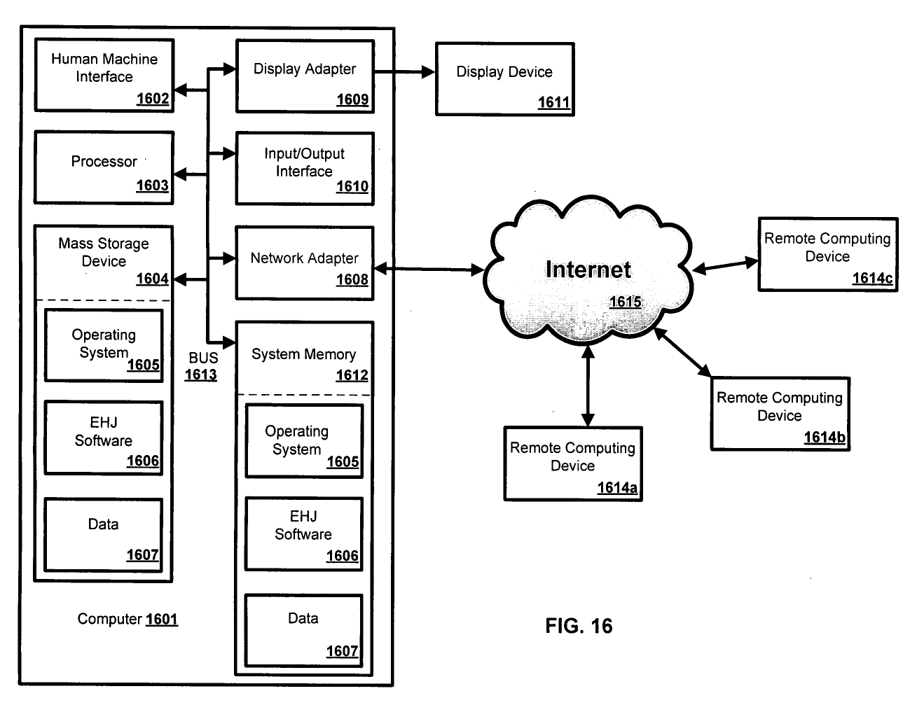

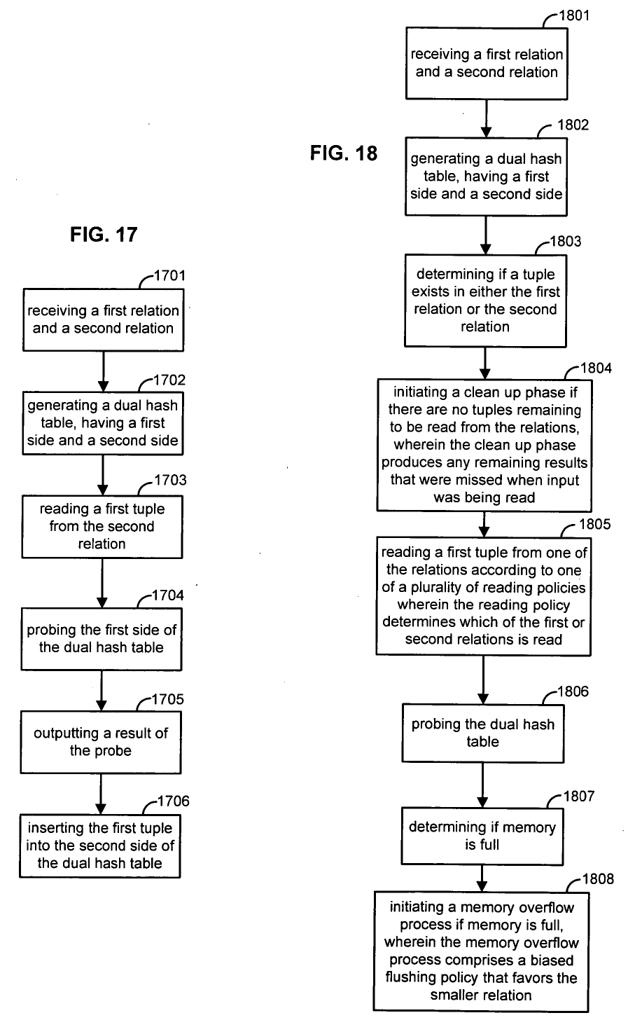

FIG. 16 is a block diagram illustrating an exemplary operating environment for performing the disclosed method. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment. One skilled in the art will appreciate that what is provided is a functional description and that the respective functions can be performed by software, hardware, or a combination of software and hardware.

The system and method of the present invention can be operational with numerous other general purpose or special purpose computing system environments or configurations. Examples of well known computing systems, environments, and/or configurations that can be suitable for use with the system and method comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

In another aspect, the system and method of the present invention can be described in the general context of computer instructions, such as program modules, being executed by a computer. Generally, program modules comprise routines, programs, objects, components, data structures, etc. that perform particular tasks or implement particular abstract data types. The system and method of the present invention can also be practiced in distributed computing environments where tasks are performed by remote processing devices that are linked through a communications network. In a distributed computing environment, program modules can be located in both local and remote computer storage media including memory storage devices.

Further, one skilled in the art will appreciate that the system and method disclosed herein can be implemented via a general-purpose computing device in the form of a computer 1601. The components of the computer 1601 can comprise, but are not limited to, one or more processors or processing units 1603, a system memory 1612, and a system bus 1613 that couples various system components including the processor 1603 to the system memory 1612.

The system bus 1613 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus also known as a Mezzanine bus. The bus 1613, and all buses specified in this description can also be implemented over a wired or wireless network connection and each of the subsystems, including the processor 1603, a mass storage device 1604, an operating system 1605, EHJ software 1606, data 1607, a network adapter 1608, system memory 1612, an Input/Output Interface 1610, a display adapter 1609, a display device 1611, and a human machine interface 1602, can be contained within one or more remote computing devices 1614a,b,c at physically separate locations, connected through buses of this form, in effect implementing a fully distributed system.

The computer 1601 typically comprises a variety of computer readable media. Exemplary readable media can be any available media that is accessible by the computer 1601 and comprises, for example and not meant to be limiting, both volatile and non-volatile media, removable and non-removable media. The system memory 1612 comprises computer readable media in the form of volatile memory, such as random access memory (RAM), and/or non-volatile memory, such as read only memory (ROM). The system memory 1612 typically contains data such as data 1607 and/or program modules such as operating system 1605 and EHJ software 1606 that are immediately accessible to and/or are presently operated on by the processing unit 1603.

In another aspect, the computer 1601 can also comprise other removable/non-removable, volatile/non-volatile computer storage media. By way of example, FIG. 16 illustrates a mass storage device 1604 which can provide non-volatile storage of computer code, computer readable instructions, data structures, program modules, and other data for the computer 1601. For example and not meant to be limiting, a mass storage device 1604 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 1604, including by way of example, an operating system 1605 and EHJ software 1606. Each of the operating system 1605 and EHJ software 1606 (or some combination thereof) can comprise elements of the programming and the EHJ software 1606. Data 1607 can also be stored on the mass storage device 1604. Data 1607 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computer 1601 via an input device (not shown). Examples of such input devices comprise, but are not limited to, a keyboard, pointing device (e.g., a “mouse”), a microphone, a joystick, a scanner, and the like. These and other input devices can be connected to the processing unit 1603 via a human machine interface 1602 that is coupled to the system bus 1613, but can be connected by other interface and bus structures, such as a parallel port, game port, an IEEE 1394 Port (also known as a Firewire port), a serial port, or a universal serial bus (USB).

In yet another aspect of the present invention, a display device 1611 can also be connected to the system bus 1613 via an interface, such as a display adapter 1609. It is contemplated that the computer 1601 can have more than one display adapter 1609 and the computer 1601 can have more than one display device 1611. For example, a display device can be a monitor, an LCD (Liquid Crystal Display), or a projector. In addition to the display device 1611, other output peripheral devices can comprise components such as speakers (not shown) and a printer (not shown) which can be connected to the computer 1601 via Input/Output Interface 1610.

The computer 1601 can operate in a networked environment using logical connections to one or more remote computing devices 1614a,b,c. By way of example, a remote computing device can be a personal computer, portable computer, a server, a router, a network computer, a peer device or other common network node, and so on. Logical connections between the computer 1601 and a remote computing device 1614a,b,c can be made via a local area network (LAN) and a general wide area network (WAN). Such network connections can be through a network adapter 1608. A network adapter 1608 can be implemented in both wired and wireless environments. Such networking environments are conventional and commonplace in offices, enterprise-wide computer networks, intranets, and the Internet 1615.

For purposes of illustration, application programs and other executable program components such as the operating system 1605 are illustrated herein as discrete blocks, although it is recognized that such programs and components reside at various times in different storage components of the computing device 1601, and are executed by the data processor(s) of the computer. An implementation of EHJ software 1606 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The processing of the disclosed system and method of the present invention can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

### III. EXAMPLES

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Proof of Correctness

In this section, the correctness of early hash join is proved by showing that it generates all output tuples and that it generates each tuple exactly once.

Theorem 1 For any two relations R and S, EHJ produces all results in R [symbol] S.

Proof. Assume an output tuple (T_{R},T_{S}) where T_{R}εR and T_{S}εS satisfies the join condition and is not generated. During the final cleanup phase of the algorithm, every partition Rᵢ of R is used as a build table for hybrid hashing. If Rᵢ is not frozen, then Rᵢ is in memory already and is processed in the first pass. If Rᵢ is frozen, it is brought into memory to construct the build table in the second pass, and its matching partition file Sᵢ is used to probe Rᵢ. Since tuples T_{R} and T_{S} will only match if they fall in the same partition (and bucket), every possible output (T_{R},T_{S}) will be generated.

The two optimizations involving early purging do not affect this result. Assume tuple T_{S} is discarded and not added to its partition P(T_{S}). T_{S} is only discarded if it is a 1:* join and it is matched with a tuple T_{R} from R or if R has been completely read and P(T_{R}) is entirely in memory. If the first case holds, then since it is a 1:* join, T_{S} has been matched with the only possible tuple T_{R} to generate (T_{R},T_{S}). If the second case holds, then T_{S} will probe and match all the tuples of R similar to if T_{S} was read from the partition file in the cleanup phase. Thus, in all cases, an output tuple (T_{R},T_{S}) is generated.

Theorem 2 For any two relations R and S, EHJ produces all output results in R [symbol] S exactly once.

Proof. Assume an output tuple (TR, TS) where T_{R}εR and T_{S}εS satisfies the join condition and is output twice as tuples O₁ and O₂. There are several cases to consider.

Case 1: Both tuples are produced in the hashing phase. Assume TS(T_{R})<TS(T_{S}). Then, T_{S} probes T_{R}'s hash table and generates an output. When T_{R} arrived, T_{S} was not in its hash table, so no output is generated. A similar argument follows for TS(T_{S})<TS(T_{R}). Thus, the hashing phase will not produce duplicate tuples.

Case 2: One tuple was produced in the hashing phase, the other in the cleanup phase or by the background process. A tuple is produced by the hashing phase if:

1. Both tuples are in memory before the P(T_{S}) is flushed: TS(T_{S})<TS_{F}(S_{P(TS)}) and TS(T_{R})<TS_{F}(S_{P(TS)}) or

2. T_{S} arrives after T_{R} and T_{S} arrives before R's partition is flushed: TS(T_{S})>TS(T_{R}) and TS(T_{S})<TS_{F}(R_{P(TS)}).

For the cleanup phase or background process to produce a duplicate tuple, it must pass one of the three conditions of the timestamp check. Condition 1 is false because either TS(T_{R})<TS_{F}(S_{P(TS)}) or TS(T_{S})>TS(T_{R}). Condition 2 is false as either TS(T_{S})<TS_{F}(S_{P(TS)}) or TS(T_{S})>TS(T_{R}). Condition 3 is false as for both possibilities TS(T_{S})<TS_{F}(R_{P(TS)})(as TS_{F}(S_{P(TS)})<TS_{F}(R_{P(TS)}) for biased flushing). No duplicate tuples are generated.

Case 3: One tuple produced by background process, the other by the background process or cleanup phase. A tuple is produced by the background process if tuple TR is in memory the last time a probe file was used containing TS: TS(TR)≦:lastProbeS. For either the background process or cleanup phase to generate a tuple already produced, it must pass one of the three conditions in the timestamp check. The addition of the condition TS(T_{R})>lastProbeS will prevent a duplicate tuple from being generated.

Case 4: Both tuples produced by cleanup phase. This is not possible as the cleanup phase uses each partition Rᵢ as a build partition once and probes it once with the matching partition Sᵢ. Thus, the algorithm does not generate duplicate tuples and produces each output result exactly once.

Experimental Evaluation

An experimental evaluation comparing the performance of dynamic hash join (DHJ), XJoin, hash-merge join (HMJ), and early hash join (EHJ) has been performed. DHJ was used as a benchmark for the fastest overall execution time as it is a variant of the standard hybrid hash join. All algorithms were implemented in Java and tested on JDK 1.5. The test machine was an Intel Pentium IV 2.8 GHz with 2 GB DDR memory and a 7200 rpm IDE hard drive running Windows XP.

The same dual hash table structure was used for all algorithms in order to remove any biases in its implementation. This hash table structure consisted of P partitions where each partition contained B buckets. A bucket stores a linked list of tuples. The hash table supported different flushing policies. Since XJoin or HMJ do not specify a reading strategy, alternate reading was selected, as it is the best fixed reading policy. Both a random data set and the standard TPC-H data set (1 GB size) for testing was used. Only the results for TPC-H are disclosed here as the random data experiments exhibited similar characteristics. Output tuples generated were discarded and not saved to disk. All data points were the average of 5 runs. A first run was executed to prime the Java HotSpot JIT compiler and its results were discarded. The garbage collector was forced to execute after each run. For all join algorithms, the standard deviation was less than 10% of the average time. The join algorithms were tested for centralized database joins where the inputs were read from the hard drive, and for mediator joins where the inputs were received over a network connection that may have delays.

Overall Experimental Results Summary

EHJ had consistently better overall performance than HMJ and XJoin. EHJs optimizations improve performance on many-to-many joins by 10%-35% and one-to-many joins by 25%-75% (or more). This overall performance did not come at the sacrifice of producing results quickly, and the response time of EHJ was an order of magnitude faster than DHJ. EHJ typically had an execution time within 10% of DHJ, and often had near identical performance.

EHJ was faster than HMJ/XJoin in almost all configurations and memory sizes. The only exception was that EHJ has roughly equivalent performance when an alternate reading strategy was used throughout a many-to-many join where both relations have the same size. In this case, no optimizations could be applied. In the many-to-many case, EHJ was faster if any one of the conditions held: alternate reading was not used throughout, the relations were not the same size, or the memory available was at least 10% of the size of the smaller relation. The relative advantage increased significantly with the ratio of the relation sizes, memory available, and with aggressive reading of the smaller relation. Of these three factors, the optimizer could control the reading strategy. EHJ was a clear winner for one-to-many joins in all cases. HMJ and XJoin did not work well with the optimizations and reading strategies discussed, as their flushing policies were not compatible with them. In a centralized database, EHJ should always be used over HMJ/XJoin.

EHJ had similar overall time and I/Os as DHJ for all types of joins when it used a biased reading strategy that favored the smaller relation. However, EHJ supports early generation of results, and allows a tradeoff of when I/Os are performed relative to when results are generated. Instead of having a large upfront cost before results are generated, reading strategies spread the I/Os throughout the join execution. Thus, EHJ did not pay the high response time penalty of DHJ and still got most of the benefits of reduced I/O operations and improved overall execution time.

Basic Algorithm Tuning

The hash table parameters P and B were tuned for each algorithm. The number of partitions P directly relates to the number of temporary files created. The best performance for HMJ was 20 partitions, and XJoin had equivalent performance between 5-40 partitions. DHJ and EHJ are more sensitive to the number of partitions because they flush frozen partitions at the page-level, which results in more random I/Os. In comparison, XJoin and HMJ flush relatively large partitions. DHJ and EHJ have better performance with a fewer number of partitions, as long as the number of partitions is large enough to ensure that individual partitions can fit in memory in the cleanup phase. Eleven partitions was the best in most cases, with larger values used for smaller memories. The page blocking factor was set to 20 tuples as TPC-H tuples have sizes between 150-225 bytes and a 4 KB page size was used.

A second factor is that all early algorithms will perform more random I/Os than dynamic hash join as they are constantly switching the input being read from. Thus, instead of reading individual tuples, several blocks are read from an input relation before switching to the other to avoid excessive random I/Os. Implementation of early algorithms can be improved by low-level I/O and buffering control.

Reading Strategy

To investigate reading strategies, EHJ was run in multiple configurations: EHJA performs alternate (1:1) reading throughout, EHJ1 starts with 1:1 reading then switches to 5:1 reading when memory is full (default EHJ configuration), EHJ2 starts with 2:1 then switches to 10:1, and EHJ* reads all the left input first similar to DHJ. The join performed was a many-to-many join in TPC-H: select * from partsupp p1, partsupp p2 where p1.p_partkey=p2.p_partkey

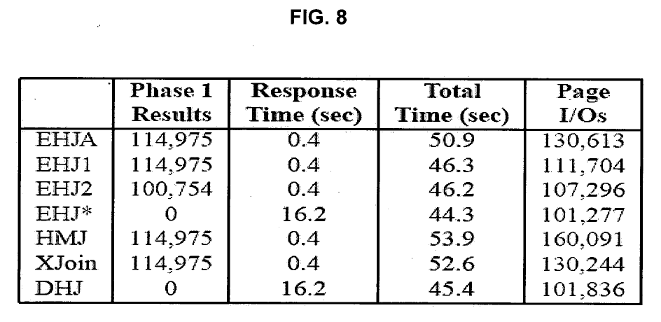

The Partsupp relation contained 800,000 tuples and the join result was 3,200,000 tuples. The memory size M=300,000 tuples. FIG. 8 indicates a summary of the performance of the algorithms in terms of response and overall times and number of page I/Os performed.

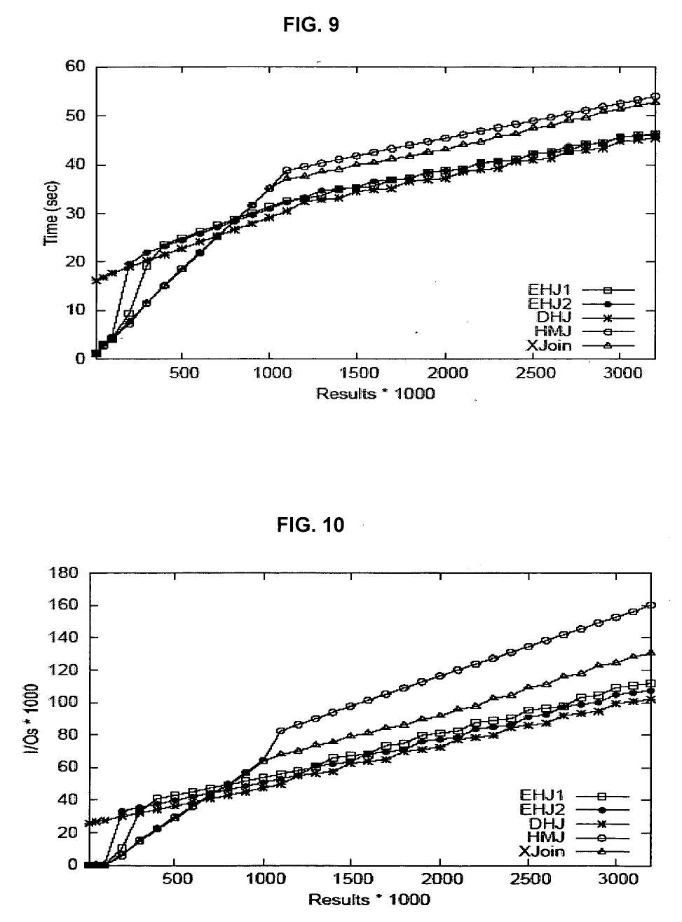

These results show that EHJ uses its optimizations to reduce the number of I/Os performed (about 14% and 30% less than XJoin and HMJ respectively). All configurations of EHJ were faster than XJoin/HMJ. All versions of EHJ returned the first 1000 results (response time) in less than a second compared to over 16 seconds for DHJ. EHJ1 was an excellent tradeoff between response time (less than 1 second) and overall execution time (only 2% slower than DHJ). EHJ* has the statistically equivalent performance as DHJ. FIGS. 9 and 10 show the execution time and number of page I/Os. This example join is the worst-case configuration for the optimizations in EHJ as both relations have the same size. If the relations are not the same size, then the relative advantage of EHJ over XJoin/HMJ increases. The formula for predicting the number of results in phase 1 before memory is full disclosed previously is accurate as it predicted 112,500 for EHJ1 and 100,000 for EHJ2.

One-to-Many Joins

The example one-to-many join shown in FIG. 11 joined the Customer (150,000 tuples) and Orders (1,500,000 tuples) relations of TPC-H on c_custkey and produced 1,500,000 result tuples. The memory size for the join was 75,000 tuples. In FIG. 11, only EHJ1 is shown as it had equivalent performance to the more aggressive EHJ2. Both EHJ1 and EHJ2 had times close to DHJ because they use biased flushing and optimizations to reduce the number of I/O operations. HMJ and XJoin cannot take full advantage of the optimizations without also performing biased flushing, but still were about 10% faster than when the optimizations were turned off. EHJ1 was 35% and 45% faster than XJoin and HMJ. EHJ had about the same time and I/Os as DHJ, but had a response time of one second compared to 4 seconds for DHJ.

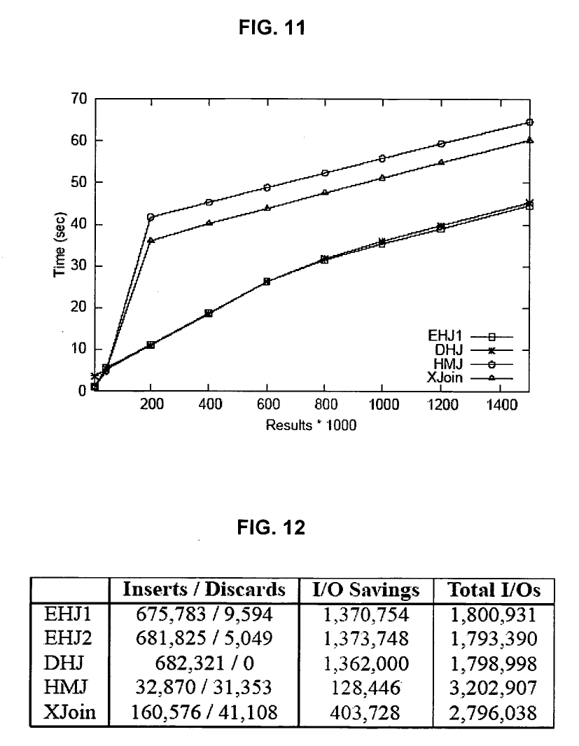

The optimizations of discarding tuples from the hash table and avoiding inserts was a major factor in the performance of the algorithms. A table showing the inserts avoided, tuples discarded from the hash table, and total tuple I/Os is in FIG. 12. HMJ was especially poor for one-to-many joins as the relation sizes were not balanced. When the smaller relation is exhausted, HMJ flushed empty partitions of the smaller input and got no benefit while reading the larger input (as the smaller input eventually gets totally flushed out of memory). This explains the large jump in FIG. 11 for both XJoin and HMJ.

Memory Size

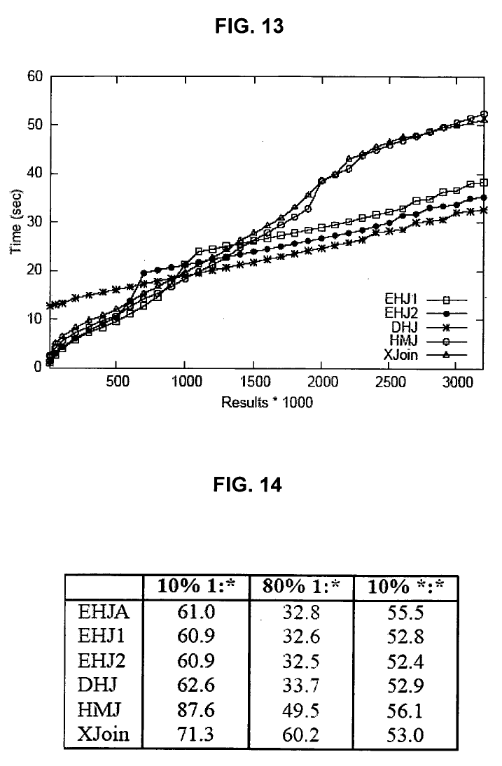

Larger memory sizes allowed EHJ to reduce the number of I/Os. Due to its higher R reading rate, EHJ2 benefits much quicker than EHJ1. For the many-to-many join (FIG. 13) with M=640,000 tuples, EHJ1 was 33% faster than XJoin and 37% faster than HMJ. For the one-to-many join with M=120,000, EHJ1/2 had almost identical performance to DHJ, and are 84% and 51% faster than XJoin/HMJ. HMJ and XJoin received less benefit of extra memory in terms of overall execution time, although the extra memory did allow them to produce more results faster. FIG. 9 shows the execution time of the various algorithms during a *:* join procedure. FIG. 10 shows the number of I/Os the various algorithms during a *:* join procedure.

For small memory sizes (<10% of smaller relation size), all algorithms had equivalent performance for *:* joins, but 1:* joins were faster with EHJ and DHJ. A smaller memory causes fewer results to be produced earlier, and provides limited opportunity for the optimizations in EHJ. However, EHJ still had a much faster response time than DHJ. A table summarizing some of these times (in seconds) for different memory sizes (as % of R) are in FIG. 14.

Multiple Joins

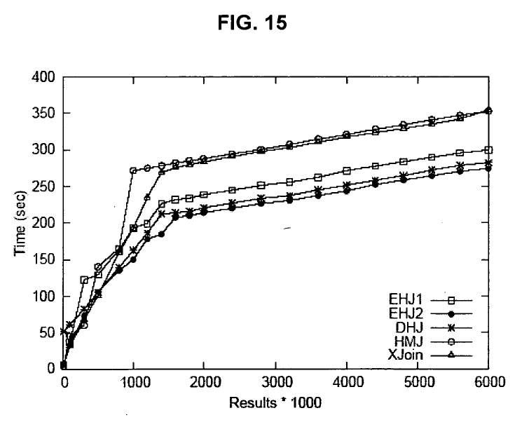

Customer-Orders-LineItem in TPC-H was joined to investigate queries with multiple joins. The size of LineItem and the join result was 6,001,215. The results are in FIG. 15. The memory size of the first join was 90,000 tuples and the second memory size was 450,000 tuples. EHJ2 had overall execution time 29% and 28% faster than XJoin and HMJ and near equivalent execution time as DHJ. The percentage improvements were not as high as the Customer-Orders example because reading and partitioning LineItem dominated the cost of the join and was the same for all algorithms.

This demonstrates that EHJ maintained its relative benefits over HMJ/XJoin for queries involving multiple joins. As with standard join processing, it is an interesting challenge to allocate memory across the individual joins. This motivates examining generalizing EHJ to a multi-way join similar to the generalization for XJoin. For example, instead of having two separate EHJ operations, a multi-way join could take all 3 relations as input in a single EHJ operator. This has the benefit that memory does not have to be individually allocated to the operators.

Mediator joins can be used when joining data across multiple data sources. The data can be stored in files, relational databases, spreadsheets, or any other form that can be converted into a table. These joins are applicable both inside a database that supports federated queries (the ability to query its own data and the data linked from other data sources) and for use in tools outside of the database that retrieve the data and perform their own processing. Data retrieval can be using some standard such as ODBC or JDBC or any other protocol.

In a mediator join, the data is retrieved from the two sources and joined at the client. Since the data has to often arrive over a network, network issues such as bandwidth, blocking, and bursty arrivals need to be dealt with. EHJ uses its background process to perform meaningful work at the client if both sources are blocked (have provided no input to the client at a certain time). Using EHJ with mediator joins improves on hybrid hash as it reads from both inputs, and thus does not block waiting for input as readily.

Mediator join results are not presented here due to space constraints. In summary, EHJ can either enter a blocked stage like XJoin or use its concurrent background process to boost the join output rate when sources are slow but not blocked. The reading “strategy” is dictated by the input arrival rates. When the join processing rate is slower than the network rate (about 10 Mbps for our hardware), a join can control its reading strategy to a high degree. In either case, the expected output rate and performance of EHJ is dictated by the “reading strategy” that it effectively sees. Finally, since EHJ biases its execution to one input, that input should be the input that is expected to arrive the fastest for *:* joins (for 1:* joins always chose the one-side). For slow networks, local join processing time is largely irrelevant as network costs dominate. For faster networks, the performance of EHJ is very close to the centralized processing case. In all cases, EHJ outperforms XJoin and HMJ for overall execution time, especially for one-to-many joins, and has a significantly better response time than DHJ.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made in the present invention without departing from the scope or spirit of the invention. Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

1. A method for joining relations comprising:
receiving a first relation and a second relation;
generating a dual hash table, having a first side and a second side;
reading a first tuple from the second relation;
probing the first side of the dual hash table;
outputting a result of the probe; and
inserting the first tuple into the second side of the dual hash table.

2. The method of claim 1, wherein the first relation is smaller than the second relation.

3. The method of claim 1, wherein tuples are read according to a reading policy.

4. The method of claim 3, wherein the reading policy is an alternating reading policy

5. The method of claim 1 further comprising, determining a relation of origin for the first tuple.

6. The method of claim 1, wherein the probing comprises:
a. determining a bucket number;
b. determining if the bucket number corresponds to a frozen partition;
c. retrieving a second tuple from the bucket;
d. comparing the first tuple and the second tuple;
e. determining if a join key of the first tuple and a join key of the second tuple match a user specified predicate;
f. outputting the join result; and
g. repeating steps c-f until every tuple in the bucket has been compared to the second tuple.

7. The method of claim 6, further comprising:
determining if the requested join is a 1:* join;
determining if the second tuple is from the *-side of the 1:* join; and deleting the second tuple, if the second tuple is from the *-side of the 1:* join.

8. The method of claim 1, wherein the inserting comprises placing the first tuple into a corresponding bucket.

9. The method of claim 1 further comprising:
determining if memory is full; and
initiating a memory overflow process if memory is full.

10. The method of claim 9, wherein the memory overflow process comprises:
determining if a memory overflow process has been previously performed;
determining if there is a non-frozen partition of the second relation
wherein the largest non-frozen partition of the second relation is flushed if there is a is a non-frozen partition of the second relation or the smallest non-frozen partition of the first relation is flushed if there is no non-frozen partition of the second relation.

11. The method of claim 10, further comprising changing the reading policy if a memory overflow process has been previously performed.

12. The method of claim 1 further comprising, initiating a clean up phase if there are no tuples remaining to be read from the relations.

13. The method of claim 12, wherein the clean up phase comprises:
determining if a clean up phase has been previously performed;
determining if there is an on-disk partition of the first relation and the second relation or only an on-disk partition of the second relation wherein the first relation is loaded into memory if there is an on-disk partition of the first relation and the second relation;
initializing a probe file for the partition containing the second relation;
reading a tuple from the probe file;
determining if there is input remaining in the probe file;
closing the probe file; and
deleting on-disk partitions.

14. The method of claim 13, wherein another tuple is read from the probe file if it is determined that input remains in the probe file.

15. The method of claim 13, wherein a second clean up phase is initialized if there is no on-disk partition of the second relation where the matching partition of the first relation is in memory.

16. The method of claim 13, wherein the join is complete if there is no on-disk partition of either the first relation or the second relation.

17. A method for joining relations comprising:
receiving a first relation and a second relation;
generating a dual hash table, having a first side and a second side;
determining if a tuple exists in either the first relation or the second relation;
initiating a clean up phase if there are no tuples remaining to be read from the relations, wherein the clean up phase produces any remaining results that were missed when input was being read;
reading a first tuple from one of the relations according to one of a plurality of reading policies wherein the reading policy determines which of the first or second relations is read;
probing the dual hash table;
determining if memory is full; and
initiating a memory overflow process if memory is full, wherein the memory overflow process comprises a biased flushing policy that favors the smaller relation.

18. The method of claim 17, further comprising:
outputting a result of the probe.

19. A system for joining relations comprising:
a memory for storing relations wherein the relations comprise tuples;
a processor coupled to the memory, wherein the processor is configured to perform the steps of:
receiving a first relation and a second relation;
generating a dual hash table, having a first side and a second side;
determining if a tuple exists in either the first relation or the second relation;
initiating a clean up phase if there are no tuples remaining to be read from the relations, wherein the clean up phase produces any remaining results that were missed when input was being read;
reading a first tuple from one of the relations according to one of a plurality of reading policies wherein the reading policy determines which of the first or second relations is read;
probing the dual hash table;
determining if memory is full; and
initiating a memory overflow process if memory is full, wherein the memory overflow process comprises a biased flushing policy that favors the smaller relation.

20. The system of claim 19, further comprising:
a display device for displaying a result of the probe.
